(19) United States
(12) Patent Application Publication
(10) Pub. No.: US 2010/0286862 A1
(43) Pub. Date: Nov. 11, 2010

(54) METHOD FOR OPERATING A MOBILE NAVIGATION DEVICE IN A VEHICLE

(76) Inventors: Eugene Fox, Vernon Hills, IL (US); Richard Malingkas, Roselle, IL (US)

Correspondence Address: QUARLES & BRADY LLP, 411 E. WISCONSIN AVENUE, SUITE 2040, MILWAUKEE, WI, 53202-4497, US

(21) Appl. No.: 12/681,427

(22) PCT Filed: Sep. 8, 2008
(86) PCT No.: PCT/DE2008/001486

§ 371 Date: Jun. 15, 2010

(30) Foreign Application Priority Data
Oct. 16, 2007 (DE) 10 2007 049 761.1

(51) Int. Cl. G06F 19/00; G01C 21/34

(52) U.S. Cl. 701/29; 701/202; 701/36; 701/45

(57) ABSTRACT

The present invention relates to a method for operating a mobile navigation device (1) in a vehicle (2), wherein the vehicle (2) is equipped with a data bus (4) on which data (vehicle data) can be transmitted, and wherein the data bus (4) features a data interface (5) for wireless transmission and reception of data, and wherein the mobile navigation device (1) comprises a data interface (7) for wireless transmission and reception of data, comprising the following steps:

a) transmitting process data of the vehicle (2) (vehicle data) via the data bus (4) and the wireless data interface (5) of the vehicle (2) to the navigation device (1), b) receiving the vehicle data at the wireless data interface (7) of the navigation device (1), c) editing and processing the vehicle data in the navigation device (1), particularly for controlling the routing process, d) transmitting process data of the navigation device (1) (navigation device data) via the wireless data interface (7) of the navigation device (1) to the vehicle, e) receiving the navigation device data at the wireless data interface (5) of the vehicle (2), and f) editing and processing the navigation device data in the vehicle.

The present invention pertains to a method for operating a mobile navigation device in a vehicle according to the preamble of claim 1.

From the state of the art mobile navigation devices are known which can be utilized in a vehicle for navigating the driver from a starting point to a destination point independently of the vehicle electronics. The navigation devices are thereby typically equipped with a satellite receiving antenna for receiving and evaluating satellite position signals. By taking into consideration the data from a road network database, a route is then calculated by the navigation device and a maneuvering instruction is output as a function of the respectively current position. Said mobile navigation devices thereby feature a separate housing and can be readily removed from the vehicle. By means of this aspect, navigation devices can be flexibly employed in various vehicle types. Moreover, said devices can be manufactured at a low cost.

The known mobile navigation devices are afflicted with the drawback that the same essentially do not allow data exchange with the vehicle control. Due to this aspect, especially sensor data of in-vehicle sensors, such as speed and/or acceleration sensors, cannot be transmitted to the mobile navigation device. If a corresponding data exchange between the mobile navigation device and the data bus of the vehicle is nevertheless desired, the navigation device needs to be wired at a corresponding interface of the data bus. Said wiring requires an extraordinary amount of effort and complexity. Besides, a wide variety of flaws may be caused when the navigation device is wired due to the large number of different vehicle types, resulting in that the corresponding assembly can only be carried out by instructed specialists.

Proceeding from this state of the art it is hence an object of the present invention to enable comprehensive data exchange between the mobile navigation device and the data bus of the vehicle in a simple fashion.

Preferred embodiments of the present invention are the subject-matter of the subclaims.

The fundamental concept of the present invention resides in the aspect that both the mobile navigation device and the vehicle bus are equipped with a wireless data interface. Via the wireless data interface, process data of the vehicle, which, in a general sense, are hereinafter referred to as vehicle data, can be transmitted to and then received by the navigation device. Said vehicle data can then be edited and processed in the navigation device, particularly for controlling the routing process. According to the inventive method, provision is at the same time equally made for transmitting process data of the navigation device, which, in a general sense, are hereinafter referred to as navigation device data to the data bus of the vehicle via the wireless data interface likewise in the reverse direction. The navigation device data are thusly available in the vehicle control system for further editing and processing and can be utilized especially for controlling navigation processes in the vehicle.

The inventive bidirectional data exchange between the mobile navigation device on the one hand and the data bus of the vehicle on the other hand can be performed upon request on the part of the user. However, this aspect is in most instances cumbersome and degrades user convenience.

It is consequently particularly advantageous if the navigation device data and vehicle data can be automatically exchanged between the navigation device and the vehicle bus. In other words, this means that no action is required to be taken on the part of the user for performing data exchange, but the necessary data are automatically communicated between the corresponding entities in the vehicle bus and in the navigation device, respectively.

In order to achieve maximum convenience as well as maximum efficiency, the navigation device should be integrated into the data bus of the vehicle via the wireless data interfaces. In other words, according to this embodiment this means that the navigation device represents only one entity among a plurality of entities which are connected via the data bus of the vehicle and which exchange data. When the vehicle is in use, the vehicle control system would then respectively check after each start of the system if a navigation device is connected at the wireless data interface. Subsequent to identification of a navigation device at the corresponding data interface, the navigation device would be activated as one entity among a plurality of entities by the vehicle control system via the vehicle bus, and data from the navigation device would be transmitted to the vehicle control system.

In order to be able to integrate the navigation device into the data bus of the vehicle in an easy manner, a joint data transmission protocol, particularly a standard data transmission protocol, should be utilized for wireless data transmission between the navigation device and the vehicle. In this way, corresponding data adjustments and data configurations on the part of the user can be prevented. If, for instance, both the navigation device and the data bus utilize a data interface in conformity with the Bluetooth data transmission standard, the navigation device can be included into the data exchange with the data bus of the vehicle in a very easy manner.

The kind of navigation device data transmitted from the navigation device to the vehicle is basically optional. According to one variation of the method, control commands for controlling processing operations in the vehicle are transmitted. Hence, it is ultimately possible to activate and control principally all functional modules of the vehicle by means of the navigation device. In this context, the controlling of lighting devices shall be cited as an example.

If the navigation device determines, for instance by accordingly evaluating the position signals, that the current position of the vehicle is located in a tunnel, a control command for switching on the vehicle lighting can be transmitted to the data bus of the vehicle in order to accordingly switch on the vehicle headlights.

Alternatively and additionally thereto, it is also conceivable that specific navigation data of the navigation device, for instance data for specifying a maneuvering instruction, are transmitted to the data bus of the vehicle. Said navigation data can then be displayed on a display device of the vehicle, for instance on a display which is installed in the vehicle anyway. In this way, functional modules of the vehicle which are installed in the vehicle anyway can also be used by the navigation device in order to thusly enhance user convenience without additional costs.

In this connection, it is in particular also conceivable that a control command for lowering the volume is transmitted to the in-vehicle radio device when maneuvering instructions are output from the navigation device.

In this way, it is prevented that the volume of the radio device drowns out the volume of the maneuvering instruction of the navigation device.

An excessively loud output of the maneuvering instructions is prevented as well. Known mobile navigation devices are typically equipped with a high-quality display device, for instance a touch screen. According to a preferred variation of the method, said display device of the navigation device can also be employed for the use of functional components of the vehicle. To this end, a corresponding user interface for controlling the functional components of the vehicle, for instance for controlling the heating system, the ventilating system and/or the air-conditioning system, can be displayed. The user commands are then entered by the user at the display device of the navigation device and are transmitted by the navigation device to the data bus of the vehicle. Subsequently, the user commands can then be executed in the functional component of the vehicle. It is thusly possible, particularly in low-priced vehicle types, to significantly enhance user convenience without additional costs, since the display device of the navigation device is additionally used for controlling functional components of the vehicle.

According to the invention, data are not only transmitted from the navigation device to the vehicle bus, but data transmission is performed likewise in the reverse direction in a bidirectional manner. According to another variation of the method, said aspect is also used for transmitting data of at least one pressure sensor, by means of which the air pressure in the tires of a vehicle is monitored, to the navigation device. This measurand is then compared with a value stored in the navigation device for specifying the tire dimensions and is corrected in case of deviations in the tire dimensions. If, for instance, the rotational speed of the tires is at the same time available, it is possible to determine the vehicle speed from the rotational speed of the tires and the precise tire dimensions in an extraordinarily accurate fashion. Hence, a highly accurate additional position signal for determining the position is available.

Another fundamental idea of the present invention resides in the aspect of utilizing the display device of the navigation device for the display of vehicle data. To this end, the corresponding vehicle data are transmitted from the vehicle bus to the navigation device and are displayed on the display device thereof. This aspect in turn allows to use the display device of the navigation device, for instance the touch screen, without additional costs in order to display to the user additional data in a detailed fashion.

Said display option through use of the display device of the navigation device is particularly advantageous for the display of vehicle fault diagnoses. Instead of activating a warning lamp in the dashboard of the vehicle, as is hitherto performed for the display of vehicle fault diagnoses, the vehicle fault diagnosis can be transmitted to the navigation device in a detailed fashion and can be appropriately displayed.

In the light of the fact that the display device of the navigation device typically features a very large display field, vehicle fault diagnoses can also be accompanied by allocated behavior-related instructions. This means that the corresponding behavior-related instructions are superimposed on the display device together with the vehicle fault diagnosis. If, for instance, the oil pressure in the engine decreases, the corresponding fault diagnosis can be displayed on the display device of the navigation device, and at the same time the user can be recommended to immediately turn off the vehicle engine. The same aspect applies if, for instance, the coolant exceeds a specific maximum temperature. In this way, reading up on corresponding behavior-related instructions in the printed vehicle instruction manual can be avoided.

Due to the fact that known mobile navigation devices do not allow data exchange with the data bus of the vehicle, the operating state of the navigation device cannot be controlled as a function of the operating state of the vehicle. This means that the driver is required to likewise deactivate the navigation device or initiate a changeover into a standby mode of the navigation device subsequent to turning the vehicle off. If such a measure is not performed, the battery of the navigation device and/or the battery of the vehicle may be undesirably emptied. By means of the inventive wireless data exchange between the navigation device and the vehicle data bus it is possible to transmit corresponding vehicle data specifying the operating state of the vehicle to the navigation device and to automatically deactivate the navigation device or automatically initiate a changeover of the navigation device into a standby mode as a function of said data. If, for instance, a signal indicative of the fact that the ignition key has been removed is transmitted in the data bus, it can be concluded therefrom that the vehicle has been parked and that the navigation device is hence no longer required to be used.

Deactivating the navigation device or initiating a changeover into the standby mode should thereby be preferably performed in a time-delayed fashion in order to preclude precipitated deactivation or changeover of the navigation device.

Insofar as the navigation device is equipped with a radio transmission device for wireless long-distance data transmission, the inventive method can be further upgraded. Vehicle data may then be transmitted from the radio transmission device of the navigation device to a receiving server and may be processed there subsequent to reception at the navigation device.

If, for instance, a safety system of the vehicle, in particular an airbag, is activated, an emergency routine can be initiated in the navigation device subsequent to reception of the corresponding signal from the vehicle bus and an emergency signal can be automatically transmitted to an emergency signal receiving server.

Alternatively or additionally thereto, it is also conceivable that a fault routine is initiated subsequent to reception of a vehicle fault diagnosis from the vehicle bus in the navigation device and that a fault signal is automatically transmitted from the radio transmission device to a service signal receiving server which, for instance, has been installed in an authorized factory.

Said upgrading of the inventive method can be realized in an especially easy and cost-efficient manner if the radio transmission device is a mobile radio component which is integrated into the navigation device. Due to the aspect that navigation devices are more and more frequently equipped with a mobile radio component or mobile radio devices are more and more frequently equipped with navigation software and thus serves as navigation devices, said functionality may then be realized without any significant additional costs.

The inventive method allows the navigation device to access all data which are transmitted via the data bus of the vehicle. In particular, all sensor data which are exchanged via the vehicle bus are evaluated and processed in the navigation device. This is of interest in particular with respect to the key task of the navigation device, i.e. the determination of the current position. If the signal quality of the position signals of the GPS satellites received by the navigation device falls below a certain quality level, for instance due to the fact that the vehicle travels under an underpass or that satellite reception is only insufficient due to deep street canyons, it is possible to automatically change over to the signal evaluation of position determining sensors which are installed in the vehicle, for instance speed sensors, gyrosensors or acceleration sensors. For determining the position, said position determining sensors of the vehicle are then evaluated.

In order to be able to utilize uniform mobile navigation devices in a wide variety of different vehicle types for sensor evaluation, it is particularly advantageous if the number of sensors whose vehicle data can be processed and evaluated in the navigation device is automatically configured. The configuration of the system for using the sensor data from the vehicle bus can then be performed without the need for configuration on the part of the user.

Insofar as a radio device having a wireless data interface, for instance a Bluetooth data interface, is available in the vehicle, the same can be readily utilized for data transmission to the navigation device.

Various aspects of the present invention are illustrated in the drawing and are hereinafter described by way of example.

In the drawing:

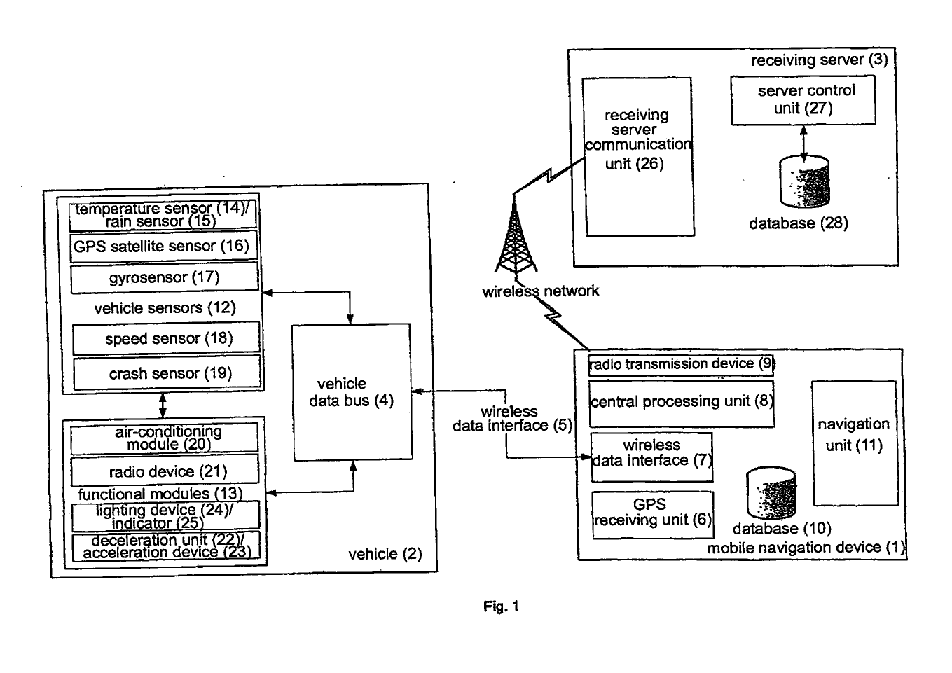

FIG. 1 illustrates the structural configuration of the functional modules of a vehicle and of a mobile navigation device for performing the inventive method.

FIG. 1 illustrates a mobile navigation device 1 and a vehicle 2 with functional modules which are illustrated in an exemplary fashion. Besides, FIG. 1 illustrates a receiving server 3 in a block diagram which is capable of exchanging data with the mobile navigation device 1. Data can be exchanged in the vehicle via a data bus 4 of the vehicle 2. A wireless data interface 5 is provided at the data bus 4 and is capable of exchanging data with a wireless data interface 7 in the mobile navigation device 1 in a wireless fashion. In this way, the mobile navigation device 1 is included into the data architecture of the vehicle data bus 4. Moreover, a GPS receiving unit 6 and a central processing unit (CPU) 8 are provided in the mobile navigation device 1 and are capable of determining the current position jointly with a navigation unit 11. Road network data for specifying a geographic territory, for instance the road network in Germany, are stored in a database 10.

Two groups of functional modules are to be distinguished in the vehicle 2. The group of vehicle sensors 12 for instance comprises a temperature sensor 14, a rain sensor 15, a GPS satellite sensor 16, a gyrosensor 17, a speed sensor 18 and a crash sensor 19 which is installed for instance in an airbag. The group of functional modules 13 comprises an air-conditioning module 20 for controlling the heating, the ventilation and the air-conditioning system, a radio device 21, a deceleration unit 22, an acceleration device 23, a lighting device 24 and an indicator 25. All of the data of the different sensors 14-19 or the different functional modules 20-25 can be activated or read via the vehicle bus. The corresponding data can be transmitted to the navigation device 1 via the wireless data interfaces 5 and 7. Data from the navigation device 1 can be transmitted to the vehicle bus via the date interfaces 5 and 7 likewise in the reverse direction and can be further transmitted to the sensors and functional modules, respectively.

In addition, a radio transmission device 9 is provided in the navigation device 1, which allows wireless data exchange with the off-board server which, for instance, serves as an emergency signal receiving server or service signal receiving server. In this way, data of the sensors 14-19 and of the functional modules 20-25 from the vehicle 2 for instance can initially be transmitted to the navigation device 1 and can then be transmitted to the receiving server 3 via the radio transmission device 9. The corresponding signals can be evaluated in the receiving server 3 and appropriate control commands can also be transmitted back to the radio transmission device 9 of the navigation device 1 in order to thusly trigger appropriate actions in the vehicle.

### LIST OF REFERENCE SIGNS

01 mobile navigation device
02 vehicle
03 ground-shielded receiving server
04 data bus
05 wireless data interface
06 GPS receiving unit
07 wireless data interface
08 central processing unit (CPU)
09 radio transmission device
10 road network database
11 navigation unit
12 group of vehicle sensors
13 group of vehicle functional modules
14 temperature sensor
15 rain sensor
16 GPS satellite sensor
17 gyrosensor
18 speed sensor
19 crash sensor
20 air-conditioning control functional module
21 radio device
22 brakes
23 acceleration device
24 lighting device
25 indicator device
26 off-board server communication protocol
27 off-board control unit
28 database

1. Method for operating a mobile navigation device in a vehicle, wherein the vehicle is equipped with a data bus on which data (vehicle data) can be transmitted, and wherein the data bus features a data interface for wireless transmission and reception of data, and wherein the mobile navigation device comprises an input device on which operator commands and/or location information, in particular starting points and/or destination points, can be entered, a road network database, a route calculation unit for calculating a planned route taking into consideration the location data and the road network database, wherein the route leads from the starting point to the destination point, a signal receiving unit for receiving position signals, in particular GPS signals, a position determining unit for determining the current position based on the position signals, at least one optical display device, a data interface for wireless transmission and reception of data and a housing in which the components of the navigation device are installed, comprising the following method steps of:
a) transmitting process data of the vehicle (vehicle data) via the data bus and the wireless data interface of the vehicle to the navigation device,
b) receiving the vehicle data at the wireless data interface of the navigation device,
c) editing and processing the vehicle data in the navigation device, particularly for controlling the routing process,
d) transmitting process data of the navigation device navigation device data) via the wireless data interface of the navigation device to the vehicle,
e) receiving the navigation device data at the wireless data interface of the vehicle, and
f) editing and processing the navigation device data in the vehicle, particularly for controlling a navigation process.

2. Method according to claim 1, in which the navigation device data and the vehicle data are automatically exchanged between the navigation device and the vehicle bus (4).

3. Method according to claim 1, in which the navigation device is integrated into the data bus of the vehicle via the wireless data interfaces.

4. Method according to claim 1, in which the data for wireless data transmission between the navigation device and the vehicle are edited in accordance with a joint data transmission protocol, in particular a standard transmission protocol.

5. Method according to claim 1, in which control commands for controlling a processing operation are transmitted from the navigation device to the vehicle in the form of navigation device data.

6. Method according to claim 5, in which when the current position is determined to be located in a tunnel, the navigation device transmits a control command for switching on the vehicle lighting to the data bus of the vehicle.

7. Method according to claim 5, in which navigation data, particularly for specifying a maneuvering instruction, are transmitted from the navigation device to the data bus of the vehicle and the navigation data is displayed on a display device of the vehicle.

8. Method according to claim 5, in which when a maneuvering instruction is output from the navigation device, a control command for lowering the volume is transmitted to the radio device in the vehicle.

9. Method according to claim 5, in which a user interface for controlling functional components of the vehicle, particularly for controlling the heating system, the ventilating system and/or the air-conditioning system, is displayed on the display device of the navigation device, wherein subsequent to the input of user commands for controlling functional components of the vehicle at the input device of the navigation device said user commands are transmitted to the data bus of the vehicle and are executed in the functional components of the vehicle.

10. Method according to claim 1, in which the data of at least one pressure sensor, by means of which the air pressure in a tire of the vehicle is monitored, are transmitted to the navigation device, wherein the value stored in the navigation device for specifying the tire dimensions is corrected as a function of the measurand of the pressure sensor.

11. Method according to claim 1, in which the vehicle data is displayed on the display device of the navigation device (1) subsequent to reception at the navigation device.

12. Method according to claim 11, in which a vehicle fault diagnosis is transmitted to the navigation device and is displayed on the display device of the navigation device.

13. Method according to claim 12, in which a behaviour-related instruction allocated to the vehicle fault diagnosis is displayed on the display device of the navigation device together with the vehicle fault diagnosis.

14. Method according to claim 1, in which as a function of the vehicle data transmitted to the navigation device, the navigation device is automatically deactivated or changed over into a standby mode.

15. Method according to claim 14, in which the deactivation or changeover into the standby mode is performed with a time delay.

16. Method according to claim 1, in which the navigation device comprises a radio transmission device for wireless long-distance data transmission, wherein vehicle data is transmitted from the radio transmission device to a receiving server subsequent to reception at the navigation device.

17. Method according to claim 16, in which subsequent to activation of a safety system of the vehicle, particularly an airbag, an emergency routine is initiated in the navigation device and an emergency signal is automatically transmitted from the radio transmission device of the navigation device to an emergency signal receiving server.

18. Method according to claim 16, in which subsequent to reception of a vehicle fault diagnosis of the vehicle, a fault routine is initiated in the navigation device and a fault signal is automatically transmitted from the radio transmission device of the navigation device to a service signal receiving server.

19. Method according to claim 16, in which a mobile radio component integrated into the navigation device is utilized as a radio transmission device.

20. Method according to claim 1, in which in determining the current position with insufficient signal quality of the position signals of a GPS satellite, an automatic changeover to signals of position determining sensors which are installed in the vehicle is performed.

21. Method according to claim 1, in which the number of sensors whose vehicle data can be processed and evaluated in the navigation device is automatically configured.

22. Method according to claim 1, in which a wireless data interface of the in-vehicle radio device is utilized for data transmission.
